(19) United States
(12) Patent Application Publication
(10) Pub. No.: US 2026/0041028 A1
(43) Pub. Date: Feb. 12, 2026

(54) Notched Opener Discs

(71) Applicant: Precision Planting LLC, Tremont, IL (US)

(72) Inventors: Jeremy Hodel, Morton, IL (US); Jordan Charles Solberg, East Peoria, IL (US)

(21) Appl. No.: 19/101,825

(22) PCT Filed: Sep. 4, 2023
(86) PCT No.: PCT/IB2023/058733

§ 371 Date: Feb. 6, 2025

Related U.S. Application Data
(60) Provisional application No. 63/375,139, filed on Sep. 9, 2022.
(60) Provisional application No. 63/375,143, filed on Sep. 9, 2022.
(60) Provisional application No. 63/385,568, filed on Nov. 30, 2022.
(60) Provisional application No. 63/434,649, filed on Dec. 22, 2022.
(60) Provisional application No. 63/434,659, filed on Dec. 22, 2022.
(60) Provisional application No. 63/434,667, filed on Dec. 22, 2022.
(60) Provisional application No. 63/434,671, filed on Dec. 22, 2022.
(60) Provisional application No. 63/501,172, filed on May 10, 2023.
(60) Provisional application No. 63/504,352, filed on May 25, 2023.

(51) Int. Cl. A01C 5/06

(52) U.S. Cl. CPC A01C 5/064

(57) ABSTRACT

An agricultural row unit (100) having: a frame (110): a trench opening assembly (120) configured to open a trench (104) in a soil surface as the trench opening assembly (120) moves in a forward direction of travel (D): the trench opening assembly (120) comprises a first disc (62), wherein the first disc (62) is notched and has a tooth (64) between notches (63); a seed conduit (130) configured to deposit seeds into the trench (104); and a trench closing assembly (146) for closing the trench (104).

### CROSS-REFERENCE TO RELATED APPLICATIONS

This application claims priority to U.S. Application No. 63/375,139, filed on 2022 Sep. 9; U.S. Application No. 63/375,143, filed on 2022 Sep. 9; U.S. Application No. 63/385,568, filed on 2022 Nov. 30; U.S. Application No. 63/434,649, filed on 2022 Dec. 22; U.S. Application No. 63/434,659, filed on 2022 Dec. 22; U.S. Application No. 63/434,667, filed on 2022 Dec. 22; U.S. Application No. 63/434,671, filed on 2022 Dec. 22; U.S. Application No. 63/501,172, filed on 2023 May 10; U.S. Application No. 63/504,352, filed on 2023 May 25, all of which are incorporated herein by reference in their entireties.

### FIELD

Embodiments of the present disclosure relate generally to notched opener discs.

### BACKGROUND

Planters with a pair of opening discs or air seeds with a single disc opener open a trench in soil for seeds to be deposited in the trench, and then the trench is closed to surround the seed with soil. Opening discs have a continuous edge with a constant radius to create a stable trench that remains open until the trench is closed.

### BRIEF SUMMARY

In an aspect of the invention there is provided agricultural row unit having: a frame; a trench opening assembly configured to open a trench in a soil surface as the trench opening assembly moves in a forward direction of travel; the trench opening assembly comprises a first disc, wherein the first disc is notched and has a tooth between notches; a seed conduit configured to deposit seeds into the trench; and a trench closing assembly for closing the trench

Within the scope of this application it should be understood that the various aspects, embodiments, examples and alternatives set out herein, and individual features thereof may be taken independently or in any possible and compatible combination. Where features are described with reference to a single aspect or embodiment, it should be understood that such features are applicable to all aspects and embodiments unless otherwise stated or where such features are incompatible.

### BRIEF DESCRIPTION OF THE DRAWINGS

One or more embodiments of the invention/disclosure will now be described, by way of example only, with reference to the accompanying drawings, in which:

FIG. 1 is a side elevation view of a row unit.

FIG. 2 is a side elevation view of the row unit of FIG. 1 with some parts removed.

FIG. 3 is a perspective view of the row unit of FIG. 2.

FIG. 4 is a perspective view of the row unit of FIG. 3 with some parts removed for viewing.

FIG. 5 is a side elevation view of components including notched opener discs.

FIG. 6 is a perspective view of a notched opener disc.

FIG. 7 is a side elevation view of the notched opener disc of FIG. 8.

FIG. 8 is a front elevation view of the notched opener disc of FIG. 8.

FIG. 9 is a rear elevation view of the notched opener disc of FIG. 8

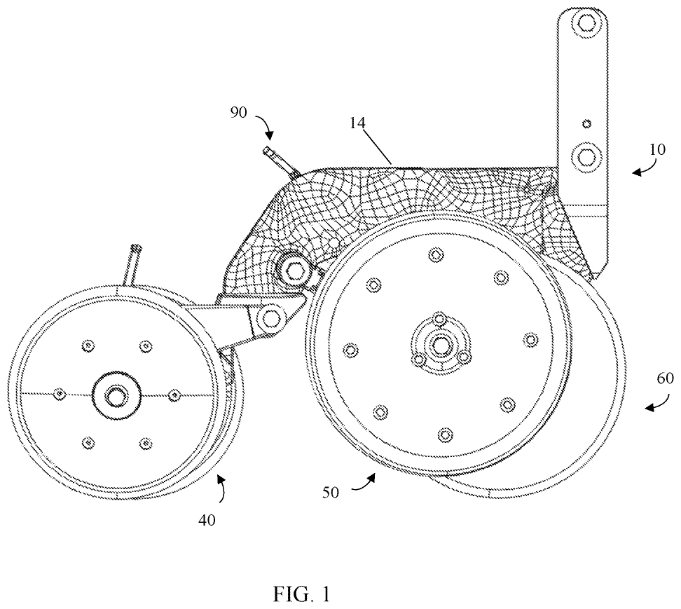

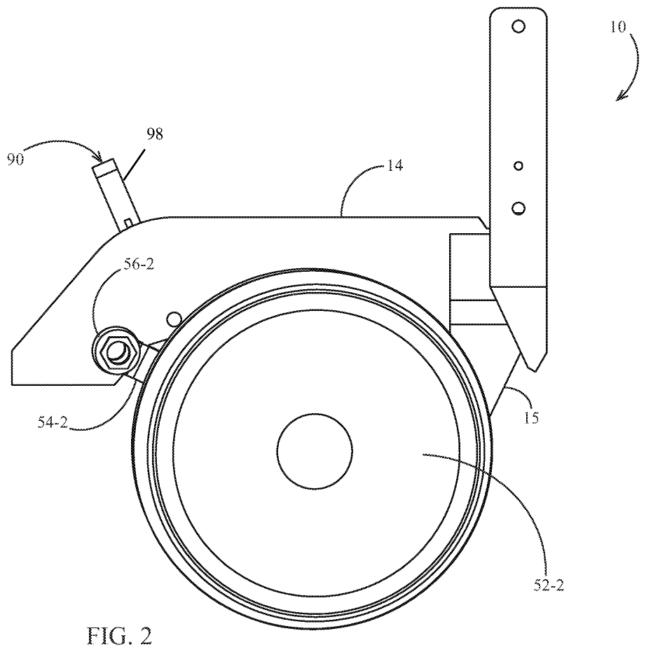

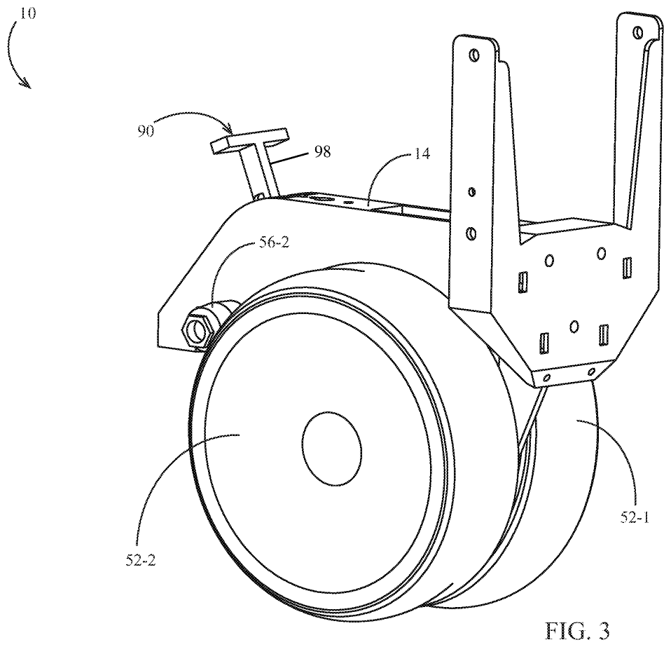

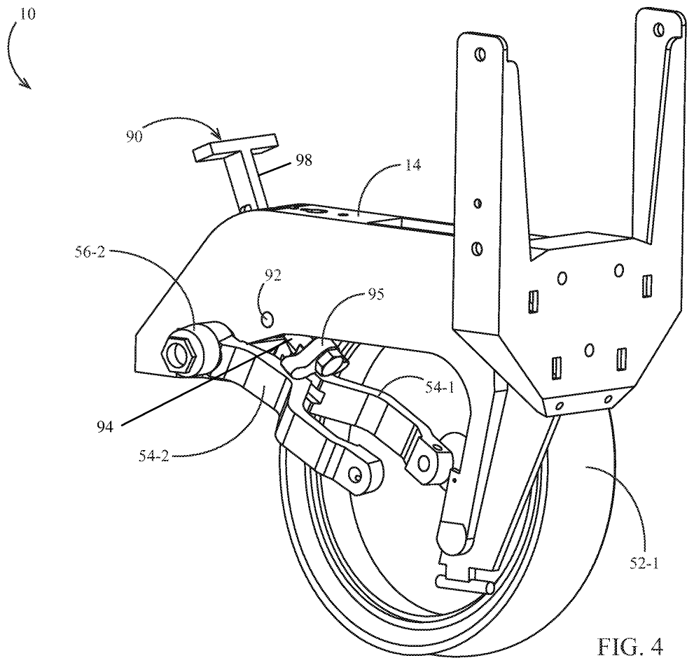

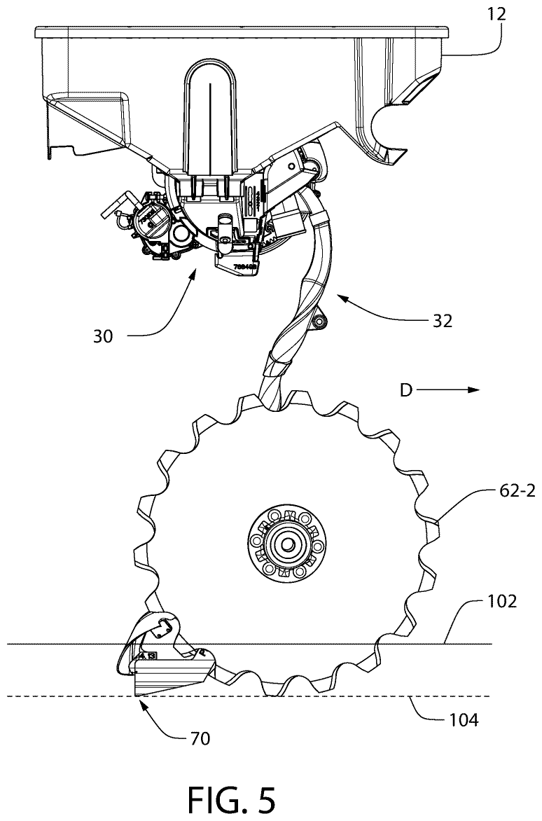

### DETAILED DESCRIPTION

All references cited herein are incorporated herein in their entireties. If there is a conflict between definitions herein and in an incorporated reference, the definition herein shall control.

The row unit 10 includes a frame 14 that moves in a forward direction of travel D. The row unit 10 includes an opening disc assembly 60. For an air seeder row unit, there is one opening disc. For a planter, opening disc assembly includes two angled opening discs 62 rollingly mounted to a downwardly extending shank 15 of the frame 14 and disposed to open a v-shaped trench 104 in a soil surface as the row unit 10 traverses a field. For an air seeder row unit, there is one gauge wheel. For a planter, row unit 10 includes a gauge wheel assembly 50 including two gauge wheels 52 pivotally mounted to either side of the frame 14 by two gauge wheel arms 54 and disposed to roll along the surface of the soil. A depth adjustment assembly 90 pivotally mounted to the frame 14 at a pivot 92 preferably contacts the gauge wheel arms 54 to limit the upward travel of the gauge wheel arms 54, thus limiting the depth of the trench opened by the opening disc assembly 60. A closing assembly 40 is coupled to the frame 14 and configured to move soil back into the trench.

The depth adjustment assembly 90 includes a rocker 95 pivotally mounted to a depth adjustment body 94. The depth adjustment body 94 is pivotally mounted to the row unit frame 14 about the pivot 92. A handle 98 is preferably slidably received within the depth adjustment body 94 such that the user can selectively engage and disengage the handle with one of a plurality of depth adjustment slots formed within the row unit frame 14. In operation, the upward travel of the gauge wheels 52 is limited by contact of the gauge wheel arms 54 with the rocker 95. When one of the gauge wheels, e.g., left gauge wheel 52-1, encounters an obstruction, the rocker 95 allows the left gauge wheel arm 54-1 to travel upward while lowering the right gauge wheel 52-2 by the same absolute displacement such that the row unit 10 rises by half the height of the obstruction.

Seeds are communicated from a hopper 12 to seed meter 30 configured to singulate supplied seeds. In one embodiment, seed meter 30 is a vacuum-type meter such as that disclosed in Applicant's International Patent Publication No. WO/2012/129442. In operation, the seed meter 30 preferably deposits the supplied seeds into a seed conduit 32, such as a seed tube. The seed tube 32 is preferably removably mounted to the frame 14. In operation, seeds deposited by the meter 30 fall through the seed tube 32 into the trench.

In other embodiments, seed tube 32 can be a seed orientation tube in which the seed rides along a surface of the seed orientation tube and air flowing over the seed orients the seed. Examples of orientation systems include PCT Publication Nos. WO2018013858A1, WO2018013859A1, WO2018013860A2, and WO2018013861A1. One particular type of seed orienter is described in U.S. Patent Publication No. US2020/0367425A1 and US2022/0192079A1.

In another embodiment, a subfurrow opener 70 can optionally be included. Subfurrow opener 90 is connected to row unit 14, such as to shank 15. Subfurrow opener 70 is disposed rearward from opening disc assembly 60 in the trench opened by opening disc assembly 60. Subfurrow opener 70 can create a more compact trench so that seeds deposited into the trench are constrained from moving to maintain their orientation in the trench. Seed tube 32 can deposit seeds into the trench after subfurrow opener 70.

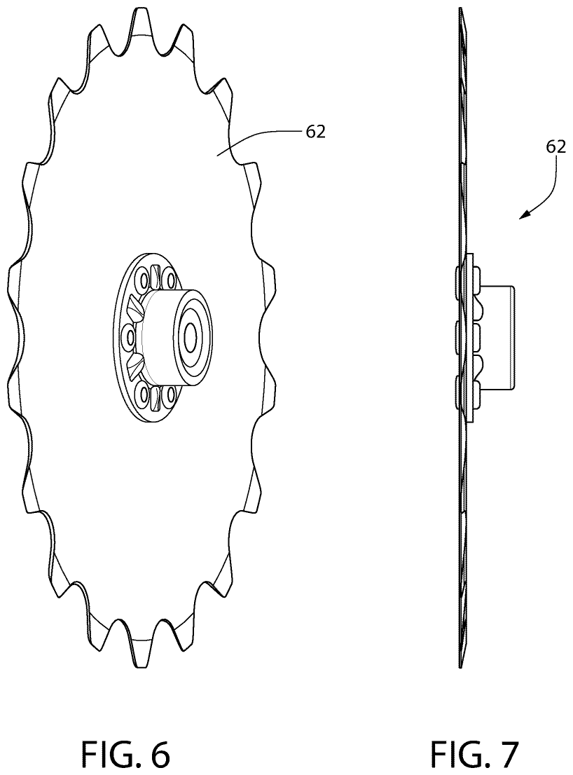

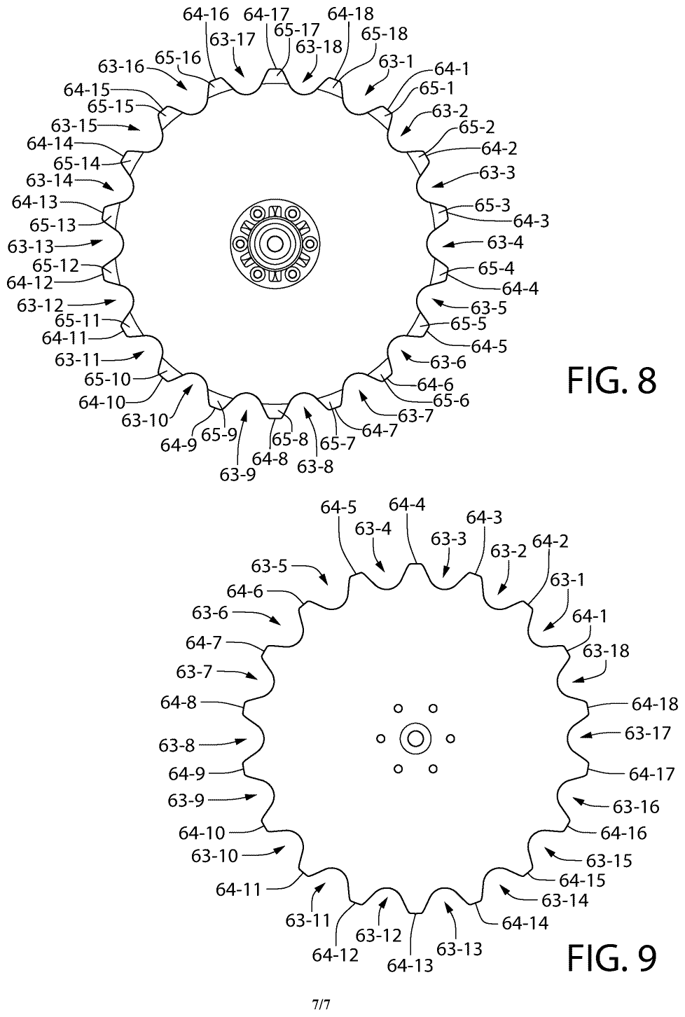

FIGS. 6-9 illustrate the notched opener disc 62. Notched opener disc 62 has a plurality of notches 63 (63-1 to 63-18). While illustrated with 18 notches, notches opener disc 62 can have any number of notches 63. Between successive notches 63 is a tooth 64. As illustrated, there are 18 teeth 64 (64-1 to 64-18). Optionally, tooth 64 can have a taper 65 (65-1 to 65-18). While illustrated with taper 65 on one side of tooth 64, both sides of tooth 64 can have a taper 65. When there is one taper 65, notched opener disc 62 can be oriented on row unit 14 such that taper 65 is disposed on notched opener disc 62 on a side away from row unit 14. While illustrated as flat, notched opener disc 62 can be concave.

Notched opener disc 62 can create a furrow in which subfurrower opener 70 can create a subfurrow without subfurrow opener 70 having to perform all of the work, which would lead to more wear on subfurrow opener 70.

### Examples

The following are nonlimiting examples.

Example 1—an agricultural row unit comprising: a frame; a trench opening assembly configured to open a trench in a soil surface as the trench opening assembly moves in a forward direction of travel; the trench opening assembly comprises a first disc, wherein the first disc is notched and has a tooth between notches; a seed conduit configured to deposit seeds into the trench; and a trench closing assembly for closing the trench.

Example 2—the agricultural row unit of Example 1, wherein the trench opening assembly comprises a second disc.

Example 3—the agricultural row unit of Example 2, wherein the second disc is notched and has a tooth between notches.

Example 4—the agricultural row unit of any preceding Example, wherein the first disc is flat.

Example 5—the agricultural row unit of any one of Examples 1 to 3, wherein the first disc is concave.

Example 6—the agricultural row unit of any preceding Example, wherein the tooth on the first disc is tapered.

Example 7—the agricultural row unit of any of Examples 3 to 6, wherein the second disc is flat.

Example 8—the agricultural row unit of any of Examples 3 to 6, wherein the second disc is concave.

Example 9—the agricultural row unit of any of Examples 3 to 8, wherein the tooth on the second disc is tapered.

Example 10—the agricultural row unit of any preceding Example further comprising a subfurrow opener connected to the frame and disposed after the trench opening assembly.

Example 11—the agricultural row unit of Example 10, wherein the seed conduit deposits seeds after the subfurrow opener.

Example 12—the agricultural row unit of any preceding Example further comprising a seed meter connected to the frame and in fluid communication with the seed conduit.

Example 13—the agricultural row unit of any preceding Example, wherein the seed conduit is a seed orientation conduit configured to orient seeds as seeds travel along the seed orientation conduit.

1. An agricultural row unit comprising:
a frame;
a trench opening assembly configured to open a trench in a soil surface as the trench opening assembly moves in a forward direction of travel;
the trench opening assembly comprises a first disc, wherein the first disc is notched and has a tooth between notches;
a seed conduit configured to deposit seeds into the trench; and
a trench closing assembly for closing the trench.

2. The agricultural row unit of claim 1, wherein the trench opening assembly comprises a second disc.

3. The agricultural row unit of claim 2, wherein the second disc is notched and has a tooth between notches.

4. The agricultural row unit of claim 1, wherein the first disc is flat.

5. The agricultural row unit of claim 1, wherein the first disc is concave.

6. The agricultural row unit of claim 1, wherein the tooth on the first disc is tapered.

7. The agricultural row unit of claim 3, wherein the second disc is flat.

8. The agricultural row unit of claim 3, wherein the second disc is concave.

9. The agricultural row unit of claim 3, wherein the tooth on the second disc is tapered.

10. The agricultural row unit of claim 1 further comprising a subfurrow opener connected to the frame and disposed after the trench opening assembly.

11. The agricultural row unit of claim 10, wherein the seed conduit deposits seeds after the subfurrow opener.

12. The agricultural row unit of claim 1 further comprising a seed meter connected to the frame and in fluid communication with the seed conduit.

13. The agricultural row unit of claim 1, wherein the seed conduit is a seed orientation conduit configured to orient seeds as seeds travel along the seed orientation conduit.
